(19) United States
(12) Patent Application Publication
(10) Pub. No.: US 2023/0230474 A1
(43) Pub. Date: Jul. 20, 2023

(54) CONTROL METHOD, RECORDING MEDIUM, AND INFORMATION SPOT

(71) Applicant: Panasonic Intellectual Property Corporation of America, Torrance, CA (US)

(72) Inventors: Junji MICHIYAMA, Fukuoka (JP); Yuji UNAGAMI, Osaka (JP); Naohisa NISHIDA, Osaka (JP); Kakuya YAMAMOTO, Hyogo (JP); Yuuki HIROSE, Osaka (JP); Motoji OHMORI, Osaka (JP); Tetsuji FUCHIKAMI, Osaka (JP)

(21) Appl. No.: 18/124,794

(22) Filed: Mar. 22, 2023

Related U.S. Application Data
(63) Continuation of application No. PCT/JP2021/036247, filed on Sep. 30, 2021.
(60) Provisional application No. 63/088,555, filed on Oct. 7, 2020.

(51) Int. Cl. G08G 1/01; H04W 4/80; H04W 4/44

(52) U.S. Cl. CPC G08G 1/0141; G08G 1/0116; H04W 4/80; H04W 4/44

(57) ABSTRACT

A control method according to the present disclosure is a method for controlling an information spot placed on at least one of a traffic light and roadside equipment and includes: obtaining, from a first mobile body via short-range wireless communication, first information obtained from a first path along which the first mobile body has traveled to reach the location of the information spot and indicating a situation on the first path; obtaining information related to the destination of a second mobile body, which is different from the first mobile body, from the second mobile body via the short-range wireless communication; and transmitting the first information to the second mobile body when it is determined that the second mobile body is to travel along at least a part of the first path to reach the destination.

### CROSS REFERENCE TO RELATED APPLICATIONS

This is a continuation application of PCT International Application No. PCT/JP2021/036247 filed on Sep. 30, 2021, designating the United States of America, which is based on and claims priority of U.S. Provisional Patent Application No. 63/088,555 filed on Oct. 7, 2020. The entire disclosures of the above-identified applications, including the specifications, drawings and claims are incorporated herein by reference in their entirety.

### FIELD

The present disclosure relates to a method for controlling an information spot, a recording medium, and an information spot.

### BACKGROUND

Conventionally, it is known that different vehicles can exchange information using vehicle-to-vehicle communication (for example, refer to Patent Literature (PTL) 1). According to PTL 1, with an information communication system using the vehicle-to-vehicle communication, it is possible to provide information that can be useful for users of nearby vehicles such as traffic information, for example.

### CITATION LIST

### Patent Literature

PTL 1: Japanese Unexamined Patent Application Publication No. 2008-021037

### SUMMARY

### Technical Problem

However, a problem with the vehicle-to-vehicle communication is that vehicles cannot exchange information unless the vehicles pass each other because, in the vehicle-to-vehicle communication, vehicles communicate directly with each other using a short-range wireless communication system in which communication is performed in a free radio frequency range that can be used within a limited area.

The present disclosure is conceived in view of the above-described circumstances and has an object to provide a control method, etc., in which mobile bodies can exchange information even without having to pass each other.

### Solution to Problem

In order to solve the aforementioned problem, according to an exemplary embodiment disclosed herein, a method for controlling an information spot placed on at least one of a traffic light or roadside equipment includes: obtaining first information from a first mobile body via short-range wireless communication, the first information being obtained from a first path along which the first mobile body has traveled to reach a location of the information spot and indicating a situation on the first path; obtaining information related to a destination of a second mobile body from the second mobile body via the short-range wireless communication, the second mobile body being different from the first mobile body; and transmitting the first information to the second mobile body when it is determined that the second mobile body is to travel along the first path to reach the destination.

Note that these general and specific aspects may be implemented using a system, a method, an integrated circuit, a computer program, or a computer-readable recording medium such as a compact disc read-only memory (CD-ROM), or any combination of systems, methods, integrated circuits, computer programs, and recording media.

### Advantageous Effects

With the control method, etc., according to the present disclosure, mobile bodies can exchange information even without having to pass each other.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram schematically illustrating a situation in which mobile bodies use an information spot according to Embodiment 1.

FIG. 2 is a block diagram illustrating one example of the functional configuration of an information spot according to Embodiment 1.

FIG. 3 is a flowchart illustrating one example of the operation of an information spot according to Embodiment 1.

FIG. 4 is a sequence chart illustrating an example process performed by mobile bodies and an information spot according to Embodiment 1.

FIG. 5 is a sequence chart illustrating an example process performed by mobile bodies and an information spot according to Variation 1 of Embodiment 1.

FIG. 6 is a sequence chart illustrating an example process performed by mobile bodies and an information spot according to Variation 2 of Embodiment 1.

FIG. 7 is a diagram schematically illustrating a situation in which mobile bodies use a plurality of information spots according to Embodiment 2.

FIG. 8 is a block diagram illustrating one example of the functional configuration of an information spot according to Embodiment 2.

FIG. 9 is a flowchart illustrating one example of the operation of an information spot according to Embodiment 2.

FIG. 10 is a flowchart illustrating one example of the operation of another information spot according to Embodiment 2.

FIG. 11 is a sequence chart illustrating an example process performed by mobile bodies and a plurality of information spots according to Embodiment 2.

FIG. 12 is a flowchart illustrating one example of the operation of an information spot according to Variation 1 of Embodiment 2.

FIG. 13 is a flowchart illustrating one example of the operation of another information spot according to Variation 1 of Embodiment 2.

FIG. 14 is a sequence chart illustrating an example process performed by mobile bodies and a plurality of information spots according to Variation 1 of Embodiment 2.

FIG. 15 is a flowchart illustrating one example of the operation of an information spot according to Variation 2 of Embodiment 2.

FIG. 16 is a sequence chart illustrating an example process performed by mobile bodies and a plurality of information spots according to Variation 2 of Embodiment 2.

FIG. 17 is a diagram schematically illustrating a situation in which mobile bodies use a plurality of information spots according to Embodiment 3.

FIG. 18 is a sequence chart illustrating an example process performed by mobile bodies and a plurality of information spots according to Embodiment 3.

FIG. 19 is a sequence chart illustrating an example process according to Embodiment 3 in which an evaluation on whether information obtained by a mobile body is correct is stored into a distributed ledger.

### DESCRIPTION OF EMBODIMENTS

According to an exemplary embodiment disclosed herein, a method for controlling an information spot placed on at least one of a traffic light or roadside equipment includes: obtaining first information from a first mobile body via short-range wireless communication, the first information being obtained from a first path along which the first mobile body has traveled to reach a location of the information spot and indicating a situation on the first path; obtaining information related to a destination of a second mobile body from the second mobile body via the short-range wireless communication, the second mobile body being different from the first mobile body; and transmitting the first information to the second mobile body when it is determined that the second mobile body is to travel along the first path to reach the destination.

With this, it is possible to provide, to the second mobile body via the information spot, the first information obtained from the first path along which the first mobile body has traveled to reach the location of the information spot and indicating a situation on the first path. Thus, the mobile bodies can exchange information even without having to pass each other.

For example, in the transmitting of the first information to the second mobile body, the first information is transmitted to the second mobile body when a second path along which it is determined that the second mobile body is to travel to reach the destination includes a section that partially overlaps the first path.

With this, even when information indicating only an address is obtained from the second mobile body as the information related to the destination of the second mobile body, whether the second mobile body is to travel along the first path to reach the destination can be determined using the second path determined as a path along which the second mobile body is to travel to reach the destination. Thus, the first information obtained from the first path and indicating a situation on the first path can be provided to the second mobile body via the information spot, meaning that the mobile bodies can exchange information even without having to pass each other.

Furthermore, for example, in the obtaining of the information related to the destination of the second mobile body via the short-range wireless communication, a second path along which the second mobile body is to travel to reach the destination is obtained from the second mobile body, and in the transmitting of the first information to the second mobile body, the first information is transmitted to the second mobile body when the second path includes a section that partially overlaps the first path.

With this, when information indicating the second path along which the second mobile body is to travel to reach the destination is obtained from the second mobile body as the information related to the destination of the second mobile body, whether the second mobile body is to travel along the first path to reach the destination can be determined using the second path obtained. Thus, the first information obtained from the first path and indicating a situation on the first path can be provided to the second mobile body via the information spot, meaning that the mobile bodies can exchange information even without having to pass each other.

Furthermore, for example, the first information may be information obtained from a sensor included in the first mobile body, and the sensor may be a dashboard camera.

With this, the information spot can obtain, as the first information, the information obtained by the sensor or the like included in the first mobile body and therefore can obtain a real situation of the first path along which the first mobile body has traveled and provide the real situation to the second mobile body.

Furthermore, according to an exemplary embodiment disclosed herein, a method for controlling a first information spot included in a plurality of information spots each placed on at least one of a traffic light or roadside equipment includes: obtaining first information from a first mobile body via short-range wireless communication, the first information being obtained from a first path along which the first mobile body has traveled to reach a location of the first information spot and indicating a situation on the first path; obtaining, from a second information spot different from the first information spot, an identifier of a second mobile body different from the first mobile body; and transmitting the first information to the second mobile body via the short-range wireless communication when it is determined based on the identifier that the second mobile body has approached the location of the first information spot.

In this way, among the plurality of information spots, the first information spot obtains the identifier of the second mobile body from another information spot, that is, the second information spot, and thus can determine an approach of the second mobile body on the basis of the obtained identifier. Thus, the first information spot can provide, to the second mobile body, the first information of the first path obtained from the first mobile body. In this way, the first information obtained by the first mobile body from the first path can be provided to the second mobile body via the plurality of information spots, meaning that the mobile bodies can exchange information even without having to pass each other.

Furthermore, according to an exemplary embodiment disclosed herein, a method for controlling a first information spot included in a plurality of information spots each placed on at least one of a traffic light or roadside equipment includes: obtaining information related to a destination of a first mobile body from the first mobile body via short-range wireless communication; obtaining first information from a second information spot different from the first information spot and located between a current location of the first mobile body and the destination, the first information being obtained from a first path along which the second mobile body has traveled to reach a location of the second information spot from the destination and indicating a situation on the first path; and transmitting the first information to the first mobile body when the short-range wireless communication with the first mobile body is available.

In this way, among the plurality of information spots, the first information spot obtains, from another information spot, that is, the second information spot, the first information of the first path obtained by the second mobile body, and thus can provide the obtained first information to the first mobile body. Thus, the first information obtained by the second mobile body from the first path can be provided to the first mobile body via the plurality of information spots, meaning that the mobile bodies can exchange information even without having to pass each other.

For example, the method further includes transmitting an identifier of the first mobile body and the first information to one or more information spots located in a direction in which the first mobile body is traveling, when the short-range wireless communication with the first mobile body is not available.

Even when the first information spot obtains, from another information spot, that is, the second information spot, the first information of the first path obtained by the second mobile body, there are cases where the first information spot cannot provide the first information to the first mobile body due to, for example, the first mobile body having traveled past the location of the first information spot. Even in this case, the first information spot can provide the identifier of the first mobile body together with the first information to another information spot and thus cause the other information spot to provide the first information to the first mobile body.

In this way, the first information obtained by the second mobile body from the first path can be provided to the first mobile body via the plurality of information spots, meaning that the mobile bodies can exchange information even without having to pass each other.

Furthermore, according to an exemplary embodiment disclosed herein, a non-transitory computer-readable recording medium having stored therein a program for causing a computer to execute a method for controlling an information spot placed on at least one of a traffic light or roadside equipment, the method including: obtaining first information from a first mobile body via short-range wireless communication, the first information being obtained from a first path along which the first mobile body has traveled to reach a location of the information spot and indicating a situation on the first path; obtaining information related to a destination of a second mobile body from the second mobile body via the short-range wireless communication, the second mobile body being different from the first mobile body; and transmitting the first information to the second mobile body when it is determined that the second mobile body is to travel along the first path to reach the destination.

Furthermore, according to an exemplary embodiment disclosed herein, a non-transitory computer-readable recording medium having stored therein a program for causing a computer to execute a method for controlling a first information spot included in a plurality of information spots each placed on at least one of a traffic light or roadside equipment, the method including: obtaining first information from a first mobile body via short-range wireless communication, the first information being obtained from a first path along which the first mobile body has traveled to reach a location of the first information spot and indicating a situation on the first path; obtaining, from a second information spot different from the first information spot, an identifier of a second mobile body different from the first mobile body; and transmitting the first information to the second mobile body via the short-range wireless communication when it is determined based on the identifier that the second mobile body has approached the location of the first information spot.

Furthermore, according to an exemplary embodiment disclosed herein, a non-transitory computer-readable recording medium having stored therein a program for causing a computer to execute a method for controlling a first information spot included in a plurality of information spots each placed on at least one of a traffic light or roadside equipment, the method including: obtaining information related to a destination of a first mobile body from the first mobile body via short-range wireless communication; obtaining first information from a second information spot different from the first information spot and located between a current location of the first mobile body and the destination, the first information being obtained from a first path along which the second mobile body has traveled to reach a location of the second information spot from the destination and indicating a situation on the first path; and transmitting the first information to the first mobile body when the short-range wireless communication with the first mobile body is available.

Furthermore, according to an exemplary embodiment disclosed herein, an information spot placed on at least one of a traffic light or roadside equipment includes: a processor; and memory, wherein the processor obtains first information from a first mobile body via short-range wireless communication, the first information being obtained from a first path along which the first mobile body has traveled to reach a location of the information spot and indicating a situation on the first path, the processor obtains information related to a destination of a second mobile body from the second mobile body via the short-range wireless communication, the second mobile body being different from the first mobile body, and the processor transmits the first information to the second mobile body when it is determined that the second mobile body is to travel along the first path to reach the destination.

Furthermore, according to an exemplary embodiment disclosed herein, an information spot that is a first information spot included in a plurality of information spots each placed on at least one of a traffic light or roadside equipment includes: a processor; and memory, wherein the processor obtains first information from a first mobile body via short-range wireless communication, the first information being obtained from a first path along which the first mobile body has traveled to reach a location of the first information spot and indicating a situation on the first path, the processor obtains, from a second information spot different from the first information spot, an identifier of a second mobile body different from the first mobile body, and the processor transmits the first information to the second mobile body via the short-range wireless communication when it is determined based on the identifier that the second mobile body has approached the location of the first information spot.

Furthermore, according to an exemplary embodiment disclosed herein, an information spot that is a first information spot included in a plurality of information spots each placed on at least one of a traffic light or roadside equipment includes: a processor; and memory, wherein the processor obtains information related to a destination of a first mobile body from the first mobile body via short-range wireless communication, the processor obtains first information from a second information spot different from the first information spot and located between a current location of the first mobile body and the destination, the first information being obtained from a first path along which the second mobile body has traveled to reach a location of the second information spot from the destination and indicating a situation on the first path, and the processor transmits the first information to the first mobile body when the short-range wireless communication with the first mobile body is available.

Hereinafter, exemplary embodiments will be described with reference to the drawings. Note that each of the exemplary embodiments described below shows one specific preferred example of the present disclosure. Specifically, the numerical values, shapes, materials, structural elements, the arrangement and connection of the structural elements, steps, the processing order of the steps, etc., shown in the following exemplary embodiments are mere examples, and are not intended to limit the present disclosure. The present disclosure is defined based on the recitations in the Claims. Therefore, among the structural elements in the following exemplary embodiments, structural elements not recited in any one of the independent claims which indicate the broadest concepts of the present disclosure are not necessarily required to achieve the object of the present disclosure, but will be described as structural elements included in preferred exemplary embodiments.

### Embodiment 1

Hereinafter, an information spot control method, etc., according to Embodiment 1 will be described with reference to the drawings.

### [Outline]

Using an information spot according to the present disclosure, mobile bodies can provide or obtain information held by the mobile bodies even without having to pass each other. The information spot according to the present disclosure will be described below.

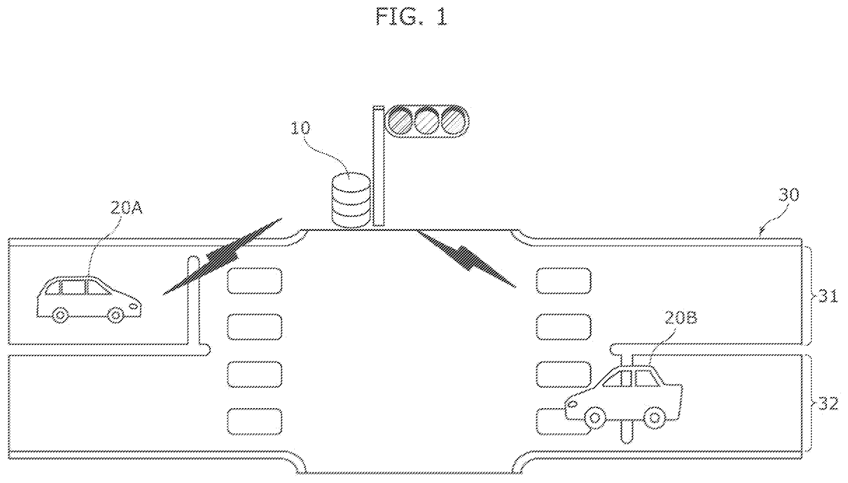

FIG. 1 is a diagram schematically illustrating a situation in which mobile bodies 20A, 20B use information spot 10 according to Embodiment 1. Note that in the following description, there are also cases where mobile bodies 20A, 20B are collectively referred to as mobile body 20.

Information spot 10 is, for example, a server device, and may be placed on a traffic light installed on the side of road 30, as illustrated in FIG. 1, but this is not limiting. Information spot 10 may be placed on roadside equipment installed on the side of road 30. In other words, it is sufficient that information spot 10 be placed on at least one of a traffic light and roadside equipment that are installed on the side of a road. Note that when roadside equipment and a traffic light include server functions, information spot 10 may be at least one of the roadside equipment and the traffic light Information spot 10 may be placed on a display installed on road 30 or on the side of road 30. The display may be a variable-message board or may be a display screen provided separately from a variable-message board. Information spot 10 can exchange information individually with mobile body 20A and mobile body 20B via short-range wireless communication to be described later.

In the example illustrated in FIG. 1, information spot 10 obtains, from mobile body 20A via the short-range wireless communication, first information obtained from a first path along which mobile body 20A has traveled to reach the location of information spot 10 and indicating a situation on the first path. Furthermore, information spot 10 obtains information related to the destination of mobile body 20B different from mobile body 20A from mobile body 20B via the short-range wireless communication. When it is determined that the second mobile body is to travel along at least a part of the first path to reach the destination, information spot 10 may transmit the first information to the second mobile body.

Mobile body 20 is, but not limited to, a car, for example. Mobile body 20 is only required to be able to exchange information with information spot 10 via the short-range wireless communication; for example, mobile body 20 may be a vehicle such as a motorcycle or a bicycle that travels on road 30 or may be an aircraft such as a drone that flies around roads.

More specifically, mobile body 20 includes one or more sensors including a dashboard camera and obtains, using the one or more sensors, information indicating a situation on a road on which mobile body 20 travels. Mobile body 20 transmits the obtained information indicating a road situation to information spot 10 via the short-range wireless communication. Note that the information indicating a road situation may be road images captured by the dashboard camera, in other words, dashcam footage, or may be metadata obtained by simplifying said images. The road situation may represent the current status of a road such as a situation in which the road is congested and a situation in which the road has been impacted by a landslide. Note that when dashcam footage includes an image of a landslide on a road, the metadata may be information obtained from the dashcam footage and indicating an avoidance instruction, for example.

Furthermore, mobile body 20 includes an automotive navigation system and transmits, to information spot 10 via the short-range wireless communication, destination information obtained from the automotive navigation system, which is related to a destination of mobile body 20, such as a destination of mobile body 20 and a path leading to the destination. Note that the destination information is, but not limited to, navigation information obtained from the automotive navigation system, for example. The destination information may be information indicating, as an intermediate destination, a transitional point in a path to be taken to reach the final destination, may be information indicating an intermediate destination and a path leading to the intermediate destination, or may be information indicating a path leading to the intermediate destination. The path leading to the intermediate destination includes one or more roads leading to the intermediate destination.

In the example illustrated in FIG. 1, mobile body 20A, which is one example of the first mobile body, is traveling on road 31 which is one lane of road 30. Mobile body 20A transmits, to information spot 10 via the short-range wireless communication, the first information obtained from the first path such as road 30 on which mobile body 20A has traveled and indicating a situation on the first path. The first information includes information indicating a situation on at least one road included in the first path.

Meanwhile, mobile body 20B, which is one example of the second mobile body, is traveling on road 32 which is an oncoming lane of road 30 opposite to road 31 in the example illustrated in FIG. 1. Mobile body 20B transmits, to information spot 10 via the short-range wireless communication, destination information such as a destination to be reached. Furthermore, mobile body 20B obtains, from information spot 10 via the short-range wireless communication, information indicating a situation on a road leading to the destination.

Note that FIG. 1 illustrates one information spot 10 and two mobile bodies 20A, 20B in order to simplify description, but this is not limiting. There may be more than one information spot 10, and there maybe three or more mobile bodies 20A, 20B.

### [Configuration]

Next, the functional configuration of information spot 10 will be described.

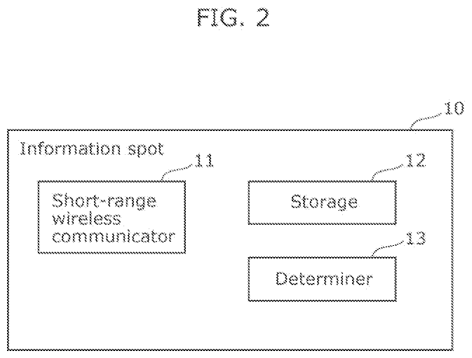

FIG. 2 is a block diagram illustrating one example of the functional configuration of the information spot according to Embodiment 1.

In the present exemplary embodiment, information spot 10 includes short-range wireless communicator 11, storage 12, and determiner 13, as illustrated in FIG. 2. Information spot 10 can be implemented by a processor executing a predetermined program using memory. Hereinafter, the structural elements will be described.

### [Short-Range Wireless Communicator 11]

Short-range wireless communicator 11 performs communication in the 700 MHz frequency band, for example, using a frequency of 760 MHz or the like. Furthermore, short-range wireless communicator 11 performs short-range wireless communication with mobile body 20 located within a few hundred meters, for example, to exchange information with mobile body 20. For example, short-range wireless communicator 11 obtains information indicating a situation on a road on which mobile body 20 has traveled or obtains information related to the destination of mobile body 20. Furthermore, for example, short-range wireless communicator 11 provides, to mobile body 20, information stored in storage 12.

In the present exemplary embodiment, short-range wireless communicator 11 obtains, from mobile body 20A, first information obtained from a first path along which mobile body 20A has traveled to reach the location of information spot 10 and indicating a situation on the first path. Furthermore, short-range wireless communicator 11 obtains, from mobile body 20B different from mobile body 20A, destination information which is related to the destination of mobile body 20B. Note that it is sufficient that the destination information include at least one of the destination of mobile body 20B and a second path along which mobile body 20 is to travel to the destination.

Furthermore, when determiner 13 determines that mobile body 20B is to travel along at least a part of the first path to reach the destination, short-range wireless communicator 11 may transmit the first information to mobile body 20B.

### [Storage 12]

Storage 12, which is a non-volatile, rewritable memory such as a hard disk drive or a solid-state drive, for example, stores information obtained from mobile body 20.

Furthermore, storage 12 stores information indicating a situation on a road on which mobile body 20 has traveled or destination information including the destination of mobile body 20.

In the present exemplary embodiment, storage 12 stores the first information obtained from mobile body 20A, which indicates a situation in the first path, or stores the destination information obtained from mobile body 20B, which is related to the destination of mobile body 20B.

### [Determiner 13]

Using the information stored in storage 12, determiner 13 determines whether information obtained from one mobile body 20 is to be provided to another mobile body 20. For example, determiner 13 determines, on the basis of the destination information for one mobile body 20 that is stored in storage 12, a path or a road on which one mobile body 20 is to travel to reach the destination. Determiner 13 determines whether a path or a road on which one mobile body 20 is to travel to reach the destination overlaps a path or a road included in the information obtained from another mobile body 20 and stored in storage 12. Note that determiner 13 may determine whether storage 12 holds information related to a road included in the destination information for one mobile body 20.

In the present exemplary embodiment, determiner 13 determines whether, on the way to the destination, mobile body 20B is to travel along at least a part of the first path along which mobile body 20A has traveled to reach the location of information spot 10. Here, in the case where the second path along which mobile body 20B is to travel to reach the destination includes a section partially overlapping the first path, determiner 13 may determine that mobile body 20B is to travel along the first path to reach the destination. Note that in the case where the destination information for mobile body 20B obtained by short-range wireless communicator 11 includes the destination only, determiner 13 may determine a second path along which mobile body 20B is predicted to travel to reach the destination.

### [Operation of Information Spot 10]

Next, the operation of information spot 10 will be described.

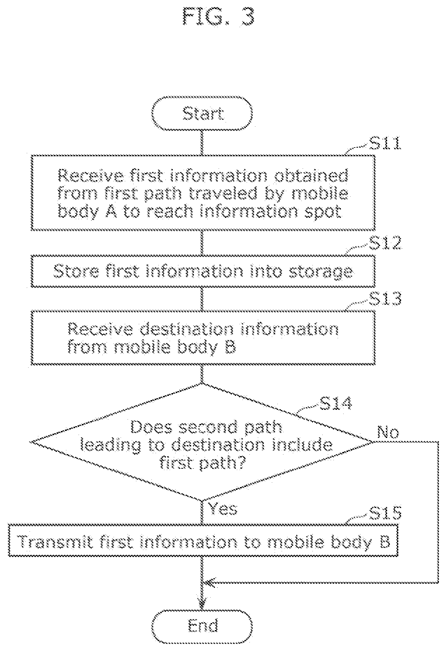

FIG. 3 is a flowchart illustrating one example of the operation of information spot 10 according to Embodiment 1. In FIG. 3, mobile bodies 20A, 20B described above are referred to as mobile bodies A, B.

As indicated in FIG. 3, first, for example, information spot 10 receives the first information obtained from the first path traveled by mobile body A to reach information spot 10 (S11). More specifically, information spot 10 obtains, from mobile body 20A via the short-range wireless communication, first information obtained from the first path along which mobile body 20A has traveled to reach the location of information spot 10 and indicating a situation on the first path. As mentioned above, the first information may be dashcam footage or may be metadata obtained from dashcam footage.

Next, information spot 10 stores, into storage 12, the first information received in Step S11 (S12).

Next, assume that information spot 10 receives the destination information from mobile body B (S13). More specifically, information spot 10 obtains the information related to the destination of mobile body 20B different from mobile body 20A from mobile body 20B via the short-range wireless communication. The information related to the destination may be information from the automotive navigation system, but it is sufficient that the information related to the destination include the destination and the second path leading to the destination. It is also sufficient that the destination indicate, as an intermediate destination, at least a transitional point in a path to be taken to reach the final destination of mobile body 20B.

Next, information spot 10 determines whether the second path for mobile body B to reach the destination includes the first path (S14). More specifically, information spot 10 determines whether mobile body 20B is to travel along the first path to reach the destination. Note that in the case where the second path along which mobile body 20B is to travel to reach the destination includes a section partially overlapping the first path, information spot 10 may determine that mobile body 20B is to travel along the first path to reach the destination. Note that in the case where the destination information for mobile body 20B received in Step S13 includes the destination only, information spot 10 may determine a second path along which mobile body 20B is predicted to travel to reach the destination.

When it is determined in Step S14 that the second path includes the first path (YES in S14), information spot 10 transmits the first information to mobile body B (S15). Note that information spot 10 may transmit the first information to the display placed on road 30 or on the side of road 30 to display the first information on the display. In this case, the first information may be displayed at the timing at which mobile body B passes by the display. Furthermore, information spot 10 may control the traffic light on the basis of the first information. For example, when the first information indicates a situation on the road, information spot 10 may cause the traffic light to flash or change colors, arrows, or the like in order to warn mobile body B. Note that information spot 10 may perform this control on the traffic light at the timing at which mobile body B passes by the traffic light.

On the other hand, when it is determined in Step S14 that the second path does not include the first path (NO in S14), information spot 10 ends the processing.

### [Example Process]

Hereinafter, an example of processing performed by information spot 10 and mobile bodies 20 will be described as a specific embodiment of the method for controlling information spot 10.

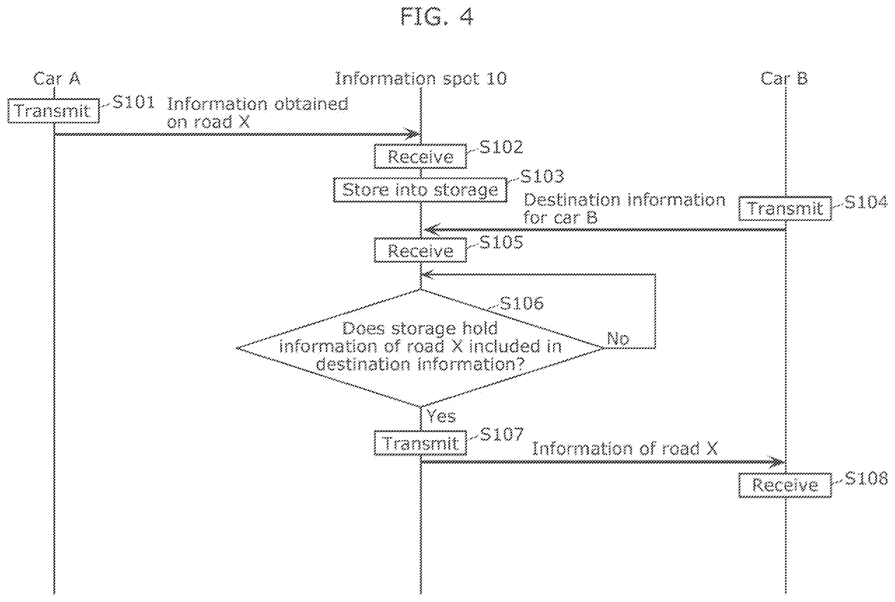

FIG. 4 is a sequence chart illustrating an example process performed by mobile bodies 20 and information spot 10 according to Embodiment 1. In FIG. 4, mobile body 20A is car A and mobile body 20B is car B. Furthermore, description will be given assuming that in the sequence illustrated in FIG. 4, car A travels on road X to the location of information spot 10 and car B travels to the location of information spot 10 and then travels on road X to reach an intended destination of a user riding in car B.

As indicated in FIG. 4, first, when car A reaches the location of information spot 10 after traveling on road X, car A transmits information obtained on road X to information spot 10 via the short-range wireless communication (S101). Road X is one example of the first path. The information obtained on road X is one example of the first information obtained from the first path and indicating a situation on the first path. The information obtained on road X is dashcam footage of road X captured by car B or metadata obtained by simplifying said dashcam footage.

Next, when information spot 10 receives the information obtained on road X that has been transmitted in Step S101 (S102), information spot 10 stores the received information into storage 12 (S103).

On the other hand, when the short-range wireless communication with information spot 10 becomes available, car B transmits destination information for car B which is related to the destination of car B (S104). The destination information for car B includes, for example, road X on which car B is to travel after reaching the location of information spot 10. The destination information for car B may be information from the automotive navigation system of car B, for example.

Next, when information spot 10 receives the destination information for car B transmitted in Step S104 (S105), information spot 10 determines whether storage 12 holds the information of road X included in the destination information for car B (S106). Note that in Step S106, information spot 10 may determine whether a road on which car B is to travel to reach the destination overlaps road X included in the information obtained from car A and stored in storage 12.

When information spot 10 determines in Step S106 that storage 12 holds the information of road X (YES in S106), information spot 10 transmits the information obtained by car A on road X and stored in storage 12 to car B as the information of road X (S107). Note that when storage 12 does not hold the information of road X in Step S106 (NO in S106), information spot 10 repeats the processing in Step S106 or ends the processing.

Next, car B receives the information of road X transmitted in Step S107 (S108). Car B may display the received information on a display unit. The display unit may be a display installed in car B or may be a terminal carried by a user in car B. Furthermore, car B may calculate, on the basis of the received information, a new path along which the path leading to the destination is bypassed, and display the new calculated path on the display unit. Furthermore, car B may control the car on the basis of the received information. For example, car B may travel along another path so as to bypass the path leading to the destination.

In this way, car A and car B can transmit and receive information via information spot 10; thus, car A and car B can exchange information even without having to pass each other.

### Variation 1

In Embodiment 1, as a specific embodiment of the method for controlling information spot 10, the example process performed by information spot 10 and mobile bodies 20 has been described with reference to FIG. 4. In the example process illustrated in FIG. 4, information spot 10 is described as receiving the destination information for car B after receiving, from car A, the information obtained on road X, but this is not limiting. There is also a case where information spot 10 receives the destination information for car B before receiving, from car A, the information obtained on road X; therefore, this case will be described as Variation 1. Note that the following description will focus on features different from the details of the example process described with reference to FIG. 4.

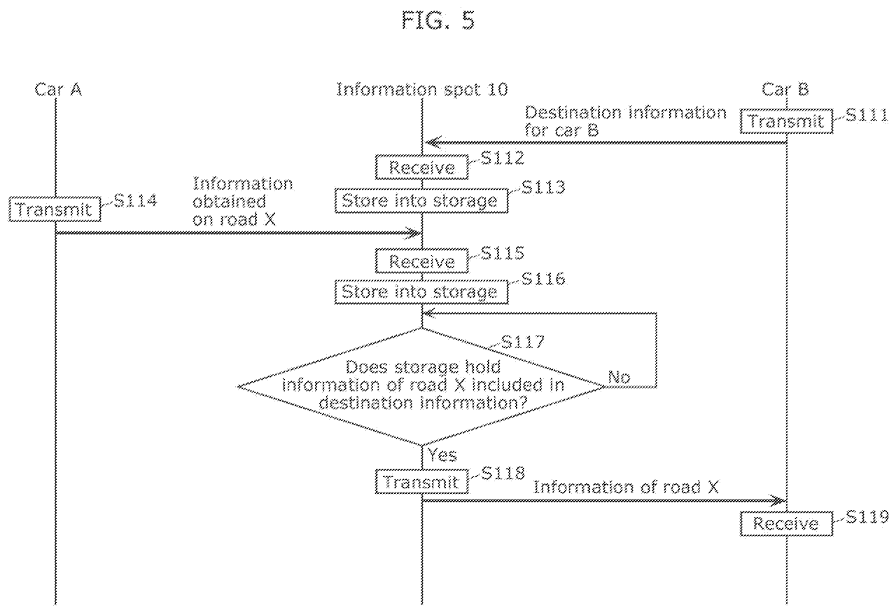

FIG. 5 is a sequence chart illustrating an example process performed by mobile bodies 20 and information spot 10 according to Variation 1 of Embodiment 1.

In FIG. 5, mobile body 20A is car A and mobile body 20B is car B, as described with reference to FIG. 4. Furthermore, description will be given assuming that in the sequence illustrated in FIG. 5, car A travels on road X to the location of information spot 10 and car B travels to the location of information spot 10 and then travels on road X to reach an intended destination of a user riding in car B, as described with reference to FIG. 4.

As indicated in FIG. 5, first, when the short-range wireless communication with information spot 10 becomes available, car B transmits destination information for car B which is related to the destination of car B (S111). Note that the destination information for car B is as described with reference to FIG. 4 and therefore, description thereof will be omitted.

Next, when information spot 10 receives the destination information for car B transmitted in Step S111 (S112), information spot 10 stores the received destination information into storage 12 (S113).

Meanwhile, when car A reaches the location of information spot 10 after traveling on road X, car A transmits information obtained on road X to information spot 10 via the short-range wireless communication (S114). Note that road X and the information obtained on road X are as described with reference to FIG. 4 and therefore, description thereof will be omitted.

Next, information spot 10 determines whether storage 12 holds the information of road X included in the destination information for car B (S117). Steps S117, S118, S119 are as described in Steps S106, S107, S108 described with reference to FIG. 4 and therefore, description thereof will be omitted.

### Variation 2

In the example process illustrated in FIG. 4, the destination information for car B obtained by information spot 10 is described as including, for example, road X on which car B is to travel after reaching the location of information spot 10, but this is not limiting. The destination information for car B may be information indicating only a destination such as an intermediate destination for which car B is to head after reaching the location of information spot 10. This case will be described as Variation 2; the following will describe features different from the details of the example process described with reference to FIG. 4

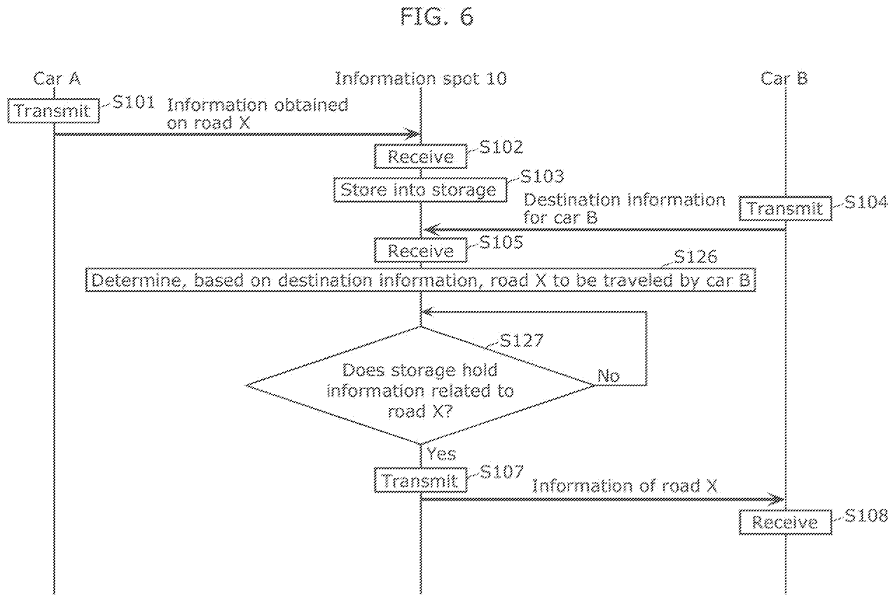

FIG. 6 is a sequence chart illustrating an example process performed by mobile bodies and an information spot according to Variation 2 of Embodiment 1. Elements that are substantially the same as those in FIG. 4 are assigned the same reference signs and detailed description thereof will be omitted. Note that Steps S101 to S104 are as described with reference to FIG. 4 and therefore, description thereof will be omitted.

Assume that in Step S105, information spot 10 receives the destination information for car B indicating only the destination of car B that has been transmitted in Step S104.

Next, on the basis of the destination information for car B received in Step S105, information spot 10 determines road X on which car B is to travel (S126). More specifically, using the destination information for car B indicating only the destination of car B, information spot 10 estimates a path including road X on which car B is to travel to reach said destination, thereby determining road X on which car B is to travel.

Next, information spot 10 determines whether storage 12 holds the information related to road X determined in Step S126 (S127). Note that in Step S127, information spot 10 may determine whether the path for car B estimated in Step S126 overlaps road X included in the information obtained from car A and stored in storage 12.

Subsequent Steps S107 and S108 are as described with reference to FIG. 4 and therefore, description thereof will be omitted.

### [Advantageous Effects, Etc.]

As described above, with the control method, etc., according to Embodiment 1, etc., the first information obtained from the first path along which the first mobile body has traveled to reach the location of the information spot and indicating a situation on the first path can be provided to the second mobile body via information spot 10 without the first mobile body and the second mobile body having to pass each other. In other words, with the control method, etc., according to Embodiment 1, etc., by using information spot 10 placed on at least one of a traffic light and roadside equipment, the first mobile body and the second mobile body can exchange information without passing each other.

Thus, the mobile bodies can exchange information even without having to pass each other.

Note that with the control method, etc., according to Embodiment 1, etc., even when information indicating only an address is obtained from the second mobile body as the information related to the destination of the second mobile body, whether the second mobile body is to travel along the first path to reach the destination can be determined using the second path determined as a path along which the second mobile body is to travel to reach the destination. When the information indicating the second path along which the second mobile body is to travel to reach the destination is obtained from the second mobile body as the information related to the destination of the second mobile body, it is sufficient that whether the second mobile body is to travel along the first path to reach the destination be determined using the second path obtained.

Furthermore, the first information is information obtained from a sensor included in the first mobile body. For example, when the sensor is a dashboard camera, the first information may be information obtained from the dashboard camera.

With this, the information spot according to Embodiment 1, etc., can obtain, as the first information, the information obtained by the sensor or the like included in the first mobile body and therefore can obtain a real situation of the first path along which the first mobile body has traveled and provide the real situation to the second mobile body.

### Embodiment 2

Embodiment 1 has described the case where the first mobile body and the second mobile body use one information spot 10 to exchange information without passing each other, but this is not limiting. There may be two or more information spots 10.

Hereinafter, the case where the first mobile body and the second mobile body exchange information using a plurality of information spots 10 without passing each other will be described as Embodiment 2.

### [Outline]

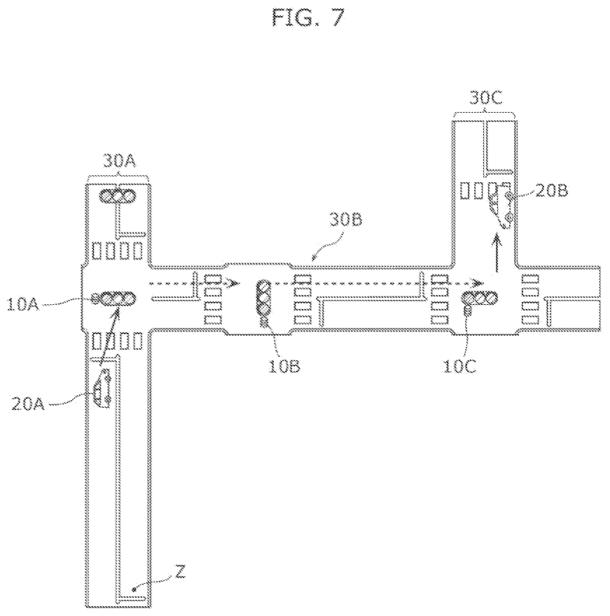

FIG. 7 is a diagram schematically illustrating a situation in which mobile bodies 20 use a plurality of information spots 10 according to Embodiment 2. Elements that are substantially the same as those in FIG. 1, etc., are assigned the same reference signs and detailed description thereof will be omitted. The following shows information spots 10A, 10B, 10C as one example of the plurality of information spots 10. There are also cases where information spots 10A, 10B, 10C are collectively referred to as information spot 10.

In the example illustrated in FIG. 7, information spot 10A obtains, as the first information from mobile body 20A, information obtained from road 30A leading to the location of information spot 10A and indicating a situation on road 30A. In other words, information spot 10A obtains, from mobile body 20A via the short-range wireless communication, the first information obtained from the first path along which mobile body 20A has traveled to reach the location of information spot 10A and indicating a situation on the first path.

Furthermore, in the example illustrated in FIG. 7, mobile body 20A travels on road 30A and transmits, as the first information to information spot 10A via the short-range wireless communication, the information obtained from road 30A on which mobile body 20A has traveled to reach the location of information spot 10A and indicating a situation on road 30A. The first information includes information indicating a situation on at least one road included in the first path.

Meanwhile, mobile body 20B travels on road 30C and after traveling past the location of information spot 10C, transmits, to information spot 10C via the short-range wireless communication, destination information including destination Z for which mobile body 20B is to head by traveling on road 30B and road 30C. Subsequently, mobile body 20B obtains, from information spot 10C via the short-range wireless communication, the information indicating situations related to roads 30B and 30A on which mobile body 20B is to travel to reach destination Z, for example.

### [Configuration]

Next, the functional configuration of information spot 10 according to Embodiment 2 will be described.

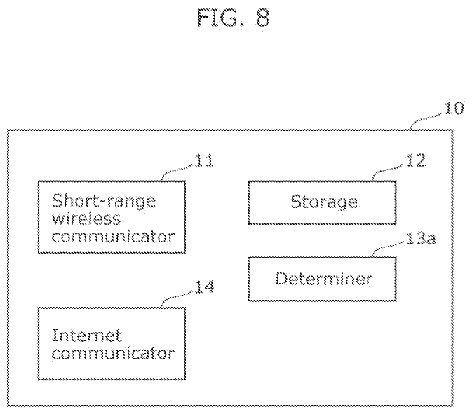

FIG. 8 is a block diagram illustrating one example of the functional configuration of information spot 10 according to Embodiment 2. Elements that are substantially the same as those in FIG. 2 are assigned the same reference signs and detailed description thereof will be omitted.

In the present exemplary embodiment, information spot 10 includes short-range wireless communicator 11, storage 12, determiner 13a, and internet communicator 14, as illustrated in FIG. 8. Information spot 10 illustrated in FIG. 8 is different from information spot 10 according to Embodiment 1 illustrated in FIG. 2 in that determiner 13a has a different configuration and internet communicator 14 is added.

[Determiner 13a]

Determiner 13a includes at least the functions of determiner 13 described in Embodiment 1 and further includes functions to be described below. As the functions of determiner 13 have already been described above, description thereof will be omitted here.

Determiner 13a determines whether transmission of the first information has been requested. When determiner 13a determines that transmission of the first information has been requested, determiner 13a specifies at least one information spot 10 that has requested the transmission of the first information.

Furthermore, when short-range wireless communicator 11 obtains the destination information related to the destination of mobile body 20B, determiner 13a specifies one or more information spots 10 located between the current location of mobile body 20B and the destination obtained from the destination information. Note that when the current location of mobile body 20B is not included in the destination information, determiner 13a may regard the location of information spot 10 of its own as the current location of mobile body 20B.

Determiner 13a may search for and specify, from among one or more information spots 10 located between the current location of mobile body 20B and the destination, at least one information spot 10 to which a request for transmission of the first information is to be sent. Note that determiner 13a may search for and specify at least one information spot 10 to which the identifier of mobile body 20B is to be transmitted. In this case, it is sufficient that determiner 13a search for and specify one or more information spots 10 located between the current location of mobile body 20B and the destination and in which the first information is stored in storage 12.

Furthermore, determiner 13a may determine whether short-range wireless communicator 11 can perform short-range wireless communication with mobile body 20B. This allows determiner 13a to determine whether mobile body 20B has come close to the location of information spot 10 of its own.

Furthermore, determiner 13a may determine whether the identifier of mobile body 20B has been obtained from another information spot 10.

### [Internet Communicator 14]

Internet communicator 14 is connected to the Internet in a wired or wireless network and thus communicates with another information spot 10 via the Internet. Internet communicator 14 may transmit or receive the location information and the identifier of another information spot 10 via the Internet.

In the present exemplary embodiment, internet communicator 14 requests at least one of the plurality of information spots 10 via the Internet to transmit the first information thereto, and thus obtains the first information. Note that internet communicator 14 may obtain the identifier of mobile body 20B together with the first information. In other words, internet communicator 14 may obtain the identifier of mobile body 20B different from mobile body 20A from information spot 10 different from information spot 10 of its own.

Furthermore, internet communicator 14 provides the first information via the Internet to at least one of the plurality of information spots 10 that have requested transmission of the first information.

Note that internet communicator 14 may provide the identifier of mobile body 20B via the Internet to one or more information spots 10 in which the first information is stored in storage 12.

### [Operation of Information Spot 10]

Next, the operation of information spot 10 according to Embodiment 2 will be described.

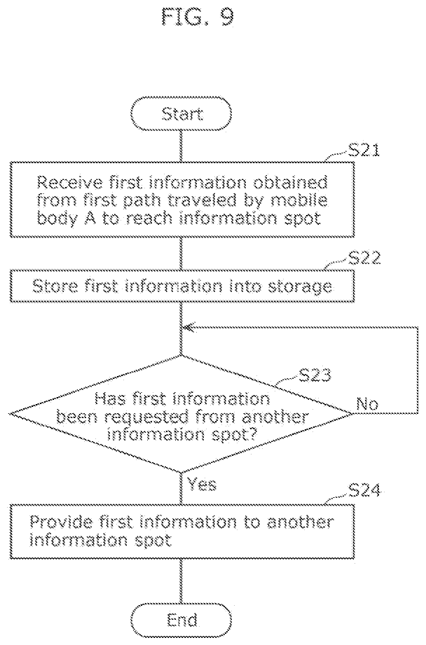

FIG. 9 is a flowchart illustrating one example of the operation of information spot 10 according to Embodiment 2. In FIG. 9, mobile body 20A is referred to as mobile body A. Information spot 10 that performs the operation illustrated in FIG. 9 is information spot 10A illustrated in FIG. 7, for example. Another information spot 10 illustrated in FIG. 9 is information spot 10C illustrated in FIG. 7, for example.

As indicated in FIG. 9, first, information spot 10A receives the first information obtained from the first path traveled by mobile body 20A to reach information spot 10 (S21). More specifically, information spot 10A obtains, from mobile body 20A via the short-range wireless communication, first information obtained from the first path along which mobile body 20A has traveled to reach the location of information spot 10 and indicating a situation on the first path. In the present exemplary embodiment, information spot 10A obtains, as the first information, the information obtained from road 30A on which mobile body 20A has traveled to reach the location of information spot 10A and indicating a situation on road 30A, as illustrated in FIG. 7, for example.

Next, information spot 10A stores, into storage 12, the first information received in Step S21 (S22).

Next, information spot 10A determines whether the first information has been requested from another information spot 10 (S23). In the present exemplary embodiment, information spot 10A determines whether the first information has been requested from, for example, information spot 10C as another information spot 10.

When information spot 10A determines in Step S23 that the first information has been requested from another information spot 10 (YES in S23), information spot 10A provides the first information to another information spot 10 (S24). In the present exemplary embodiment, information spot 10A provides the first information to, for example, information spot 10C as another information spot 10. Note that when the first information has not been requested from another information spot 10 in Step S23 (NO in S23), information spot 10A repeats the processing in Step S23.

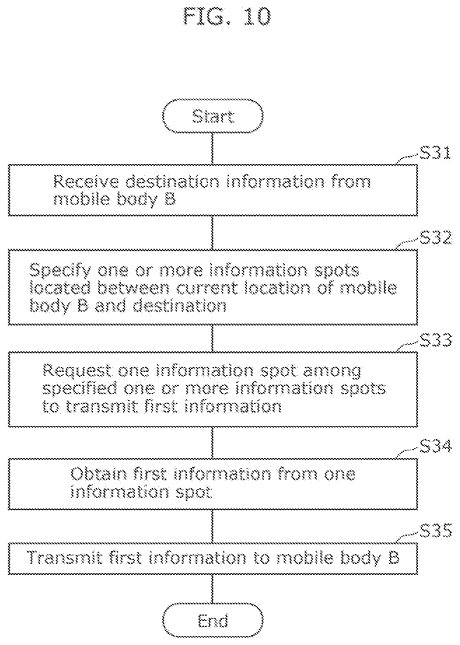

FIG. 10 is a flowchart illustrating one example of the operation of another information spot 10 according to Embodiment 2. In FIG. 10, mobile body 20B is referred to as mobile body B. Another information spot 10 that performs the operation illustrated in FIG. 10 is information spot 10C illustrated in FIG. 7, for example. One information spot indicated in FIG. 10 is information spot 10A illustrated in FIG. 7, for example.

As indicated in FIG. 10, first, information spot 10C, which is another information spot 10, receives the destination information from mobile body B (S31). In the present exemplary embodiment, information spot 10C obtains information related to the destination of mobile body 20B different from mobile body 20A from mobile body 20B via the short-range wireless communication. Note that the information related to the destination is as described in Embodiment 1, etc., and therefore description thereof will be omitted.

Next, information spot 10C, which is another information spot 10, specifies one or more information spots 10 located between the current location of mobile body B and the destination (S32). Here, information spot 10C can obtain the destination of mobile body 20B from the destination information for mobile body 20B received in Step S31. In the example illustrated in FIG. 7, information spot 10C specifies information spots 10C, 10B, 10A located between the current location of mobile body 20B and destination Z which is the destination of mobile body 20B.

Next, information spot 10C, which is another information spot 10, requests one information spot among the one or more information spots 10 specified in Step S32 to transmit the first information thereto (S33). In the example illustrated in FIG. 7, information spot 10C specifies information spot 10A as one information spot 10 from among information spots 10C, 10B, 10A specified in Step S32 and requests specified information spot 10A to transmit the first information thereto.

Next, information spot 10C, which is another information spot 10, obtains the first information from one information spot 10 (S34). In the example illustrated in FIG. 7, information spot 10C obtains, as the first information from information spot 10A, information of road 30A, that is, the information obtained from road 30A on which mobile body 20A has traveled to reach the location of information spot 10A and indicating a situation on road 30A.

Next, information spot 10C, which is another information spot 10, transmits, to mobile body B, the first information obtained in Step S32 (S35).

### [Example Process]

Hereinafter, an example of processing performed by a plurality of information spots 10 and mobile bodies 20 will be described as a specific embodiment of the method for controlling information spot 10 according to Embodiment 2.

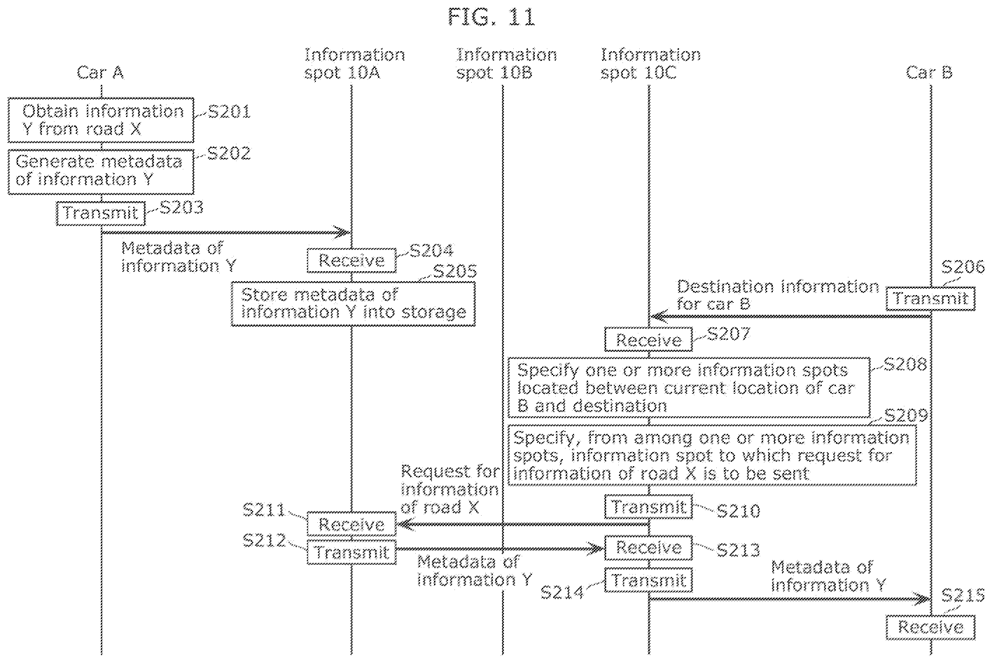

FIG. 11 is a sequence chart illustrating an example process performed by mobile bodies 20 and the plurality of information spots 10 according to Embodiment 2. In FIG. 11, mobile body 20A is car A and mobile body 20B is car B. There is more than one information spot 10; assume that there are information spots 10A, 10B, 10C placed on respective signal lights as illustrated in FIG. 7, for example. Furthermore, description will be given assuming that in the sequence illustrated in FIG. 11, car A travels on road X to the location of information spot 10A, and car B travels to the location of information spot 10C, then travels on a road on which information spot 10B is present, travels on road X on which information spot 10C is present, and reaches a destination that is the intermediate destination of car B.

As indicated in FIG. 11, first, car A obtains information Y indicating a situation on road X while traveling on road X (S201), and generates metadata of information Y obtained (S202). The metadata is data of information Y that has been reduced in data amount, that is, information obtained by simplifying information Y. Note that road X and information Y obtained on road X are as described with reference to FIG. 4 and therefore, description thereof will be omitted.

Next, when car A reaches the location of information spot 10, car A transmits the metadata of information Y as the information obtained on road X to information spot 10A via the short-range wireless communication (S203).

Next, when information spot 10A receives the metadata of information Y transmitted in Step S203 (S204), information spot 10A stores the received metadata of information Y into storage 12 (S205).

On the other hand, when the short-range wireless communication with information spot 10C becomes available, car B transmits, to information spot 10C, destination information for car B which is related to the destination of car B (S206). Note that the destination information for car B is as described with reference to FIG. 4 and therefore, description thereof will be omitted.

Next, when information spot 10C receives the destination information for car B transmitted in Step S206 (S207), information spot 10C stores the received destination information into storage 12.

Next, information spot 10C specifies one or more information spots 10 located between the current location of car B and the destination (S208). Here, information spot 10C can obtain the destination of car B from the destination information for car B received in Step S207. With this, information spot 10C can specify information spots 10C, 10B, 10A located between the current location of car B and the destination.

Next, information spot 10C specifies, from among one or more information spots 10 specified in Step S208, information spot 10 to which a request for information of road X that indicates a situation on road X is to be sent (S209). Here, information spot 10C specifies, from among information spots 10C, 10B, 10A specified in Step S208, information spot 10A to which a request for the information of road X is to be sent.

Next, information spot 10C transmits, to information spot 10 specified in Step S209, a message indicating that the information of road X is requested (S210). Here, information spot 10C requests information spot 10A specified in Step S209 to transmit the information of road X thereto.

Next, when information spot 10A receives the message indicating that the information of road X is requested (S211), information spot 10A transmits the metadata of information Y stored in storage 12 as the information of road X (S212).

Next, information spot 10C obtains the metadata of information Y from information spot 10A (S213).

Next, information spot 10C transmits, to car B, the metadata of information Y indicating a situation on road X that has been received in Step S213 (S214).

Next, car B receives the metadata of information Y transmitted in Step S214 (S215).

In this way, car A and car B can transmit and receive information via the plurality of information spots 10; thus, car A and car B can exchange information even without having to pass each other.

Note that in FIG. 11, in order to reduce burden on Internet communications, the metadata of information Y obtained on road X is generated and used as the information of road X, but this is not limiting. Information Y obtained on road X may be directly used instead.

### Variation 1

Embodiment 1 has described, with reference to FIG. 9, the operation of information spot 10A, out of information spots 10A, 10B, 10C illustrated in FIG. 7, as the operation of one information spot 10 included in the plurality of information spots 10. The operation indicated in FIG. 9 is described as an operation performed when information spot 10A receives, from car A, the information obtained on road X, and then provides said information to information spot 10C, and information spot 10C transmits, to car B, the information obtained by car A on road X; however, this is not limiting. Information spot 10A illustrated in FIG. 7 may transmit, directly to car B, the information obtained on road X and received from car A, when the short-range wireless communication with information spot 10A becomes available to car B. This case will be described below as Variation 1. Note that the following description will focus on features different from the operation described with reference to FIG. 9.

### [Operation of Information Spot 10]

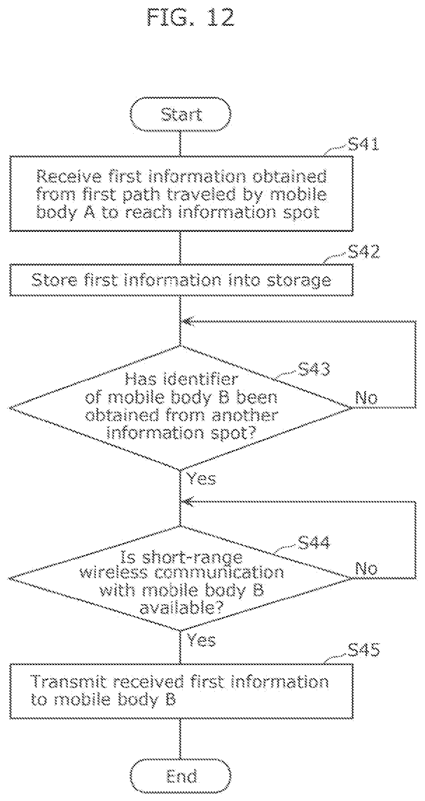

FIG. 12 is a flowchart illustrating one example of the operation of information spot 10A according to Variation 1 of Embodiment 2. Note that Steps S41 and S42 correspond to Steps S21 and S22 described with reference to FIG. 9 and therefore, description of Steps S41 and S42 will be omitted.

Next, information spot 10A determines whether the identifier of mobile body B has been obtained from another information spot 10 (S43). In the present variation, information spot 10A determines whether the identifier of mobile body B has been obtained from another information spot 10, for example, information spot 10C.

When information spot 10A determines in Step S43 that the identifier of mobile body B has been obtained from another information spot 10 (YES in S43), information spot 10A further determines whether the short-range wireless communication with mobile body B is available (S44). Here, for example, assume that information spot 10A obtains the identifier of mobile body 20B different from mobile body 20A from information spot 10C different from information spot 10A itself. In this case, it is sufficient that according to whether there is a match between the identifier obtained when the short-range wireless communication with one mobile body 20 is established and the identifier of mobile body 20B obtained from another information spot 10, information spot 10A determine whether the short-range wireless communication with mobile body 20B has become available. Note that when information spot 10A determines in Step S43 that the identifier of mobile body B has not been obtained from another information spot 10 (NO in S43), information spot 10A may repeat the processing in Step S43.

When information spot 10A determines in Step S44 that the short-range wireless communication with mobile body B has become available (YES in S44), information spot 10A transmits the first information to mobile body B (S45). More specifically, when it is determined on the basis of the identifier of mobile body B obtained from another information spot 10 that the short-range wireless communication with information spot 10A has become available to mobile body B and mobile body B has approached the location of information spot 10A, information spot 10A transmits the first information to mobile body B via the short-range wireless communication.

Note that when information spot 10A determines in Step S44 that the short-range wireless communication with mobile body B has not become available (NO in S44), information spot 10A may repeat the processing in Step S44.

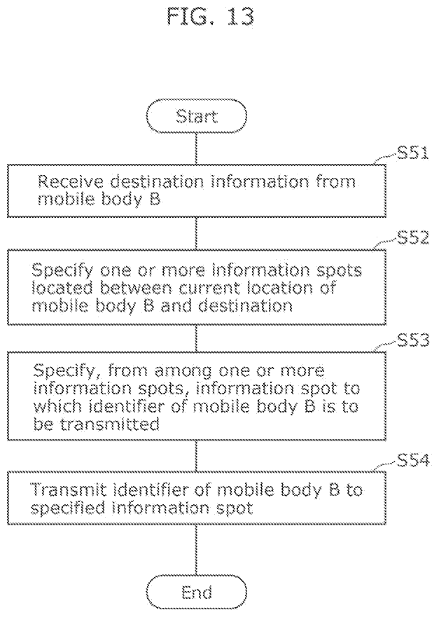

Embodiment 1 has described, with reference to FIG. 10, the operation of information spot 10C, out of information spots 10A, 10B, 10C illustrated in FIG. 7, as the operation of one information spot 10 included in the plurality of information spots 10. The operation indicated in FIG. 10 is described as an operation performed when information spot 10C obtains the information obtained by car A on road X, for example, from information spot 10A that has received, from car A, the information obtained on road X, and then provides said information to car B; however, this is not limiting. Information spot 10C illustrated in FIG. 7 may transmit the identifier of car B to at least one of other information spots 10 located between the current location of car B and the destination so that another information spot 10 provides, to car B, the information obtained by car A on road X. Hereinafter, features different from the operation described with reference to FIG. 10 will be mainly described with reference to FIG. 13.

FIG. 13 is a flowchart illustrating one example of the operation of another information spot 10 according to Variation 1 of Embodiment 2. Note that Steps S51 and S52 correspond to Steps S31 and S32 described with reference to FIG. 10 and therefore, description of Steps S51 and S52 will be omitted.

Next, information spot 10C as another information spot 10 specifies, from among one or more information spots 10 specified in Step S52, information spot 10 to which the identifier of mobile body B is to be transmitted (S53). In the present variation, information spot 10C specifies, from among information spots 10C, 10B, 10A specified in Step S52, information spot 10A to which the identifier of mobile body B is to be transmitted.

Next, information spot 10C transmits the identifier of mobile body B to the information spot specified in Step S53 (S54). In the present variation, information spot 10C transmits the identifier of mobile body B to information spot 10A, for example.

### [Example Process]

Hereinafter, an example of processing performed by three information spots 10 and two mobile bodies 20 will be described as a specific embodiment of the method for controlling information spot 10 according to Variation 1 of Embodiment 2.

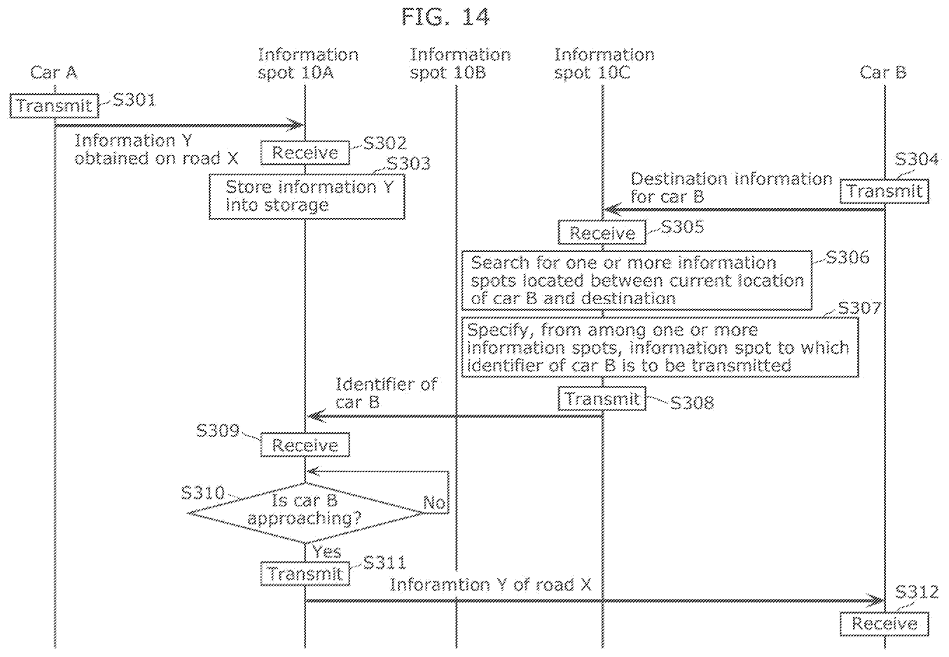

FIG. 14 is a sequence chart illustrating an example process performed by mobile bodies 20 and the plurality of information spots 10 according to Variation 1 of Embodiment 2. Similar to FIG. 11, mobile body 20A is car A and mobile body 20B is car B in FIG. 14. There is more than one information spot 10; assume that there are information spots 10A, 10B, 10C placed on respective signal lights as illustrated in FIG. 7, for example. Furthermore, description will be given assuming that in the sequence illustrated in FIG. 14, car A travels on road X to the location of information spot 10A, and car B travels to the location of information spot 10C, then travels on a road on which information spot 10B is present, travels on road X on which information spot 10C is present, and reaches a destination that is the intermediate destination of car B.

First, car A has obtained information Y indicating a situation on road X while traveling on road X, and when car A reaches the location of information spot 10A after traveling on road X, car A transmits information Y obtained on road X to information spot 10A via the short-range wireless communication, as indicated in FIG. 14 (S301). Note that car A may generate metadata of information Y obtained and transmit the generated metadata to information spot 10A as information Y obtained on road X. Road X and information Y obtained on road X are as described with reference to FIG. 4 and therefore, description thereof will be omitted.

Next, when information spot 10A receives information Y of road X transmitted in Step S301 (S302), information spot 10A stores received information Y of road X into storage 12 (S303).

Meanwhile, when the short-range wireless communication with information spot 10C becomes available to car B during travel on a road, car B transmits, to information spot 10C, destination information for car B which is related to the destination of car B (S304). Note that the destination information for car B is as described with reference to FIG. 4 and therefore, description thereof will be omitted.

Next, when information spot 10C receives the destination information for car B transmitted in Step S304 (S305), information spot 10C stores the received destination information into storage 12.

Next, information spot 10C searches for and specifies one or more information spots 10 located between the current location of car B and the destination (S306). Here, information spot 10C can obtain the destination of car B from the destination information for car B received in Step S305. Therefore, information spot 10C can search for and specify information spots 10C, 10B, 10A located between the current location of car B and the destination.

Next, information spot 10C specifies, from among one or more information spots 10 searched for and specified in Step S306, information spot 10 to which the identifier of car B is to be transmitted (S307). Here, information spot 10C specifies, from among information spots 10C, 10B, 10A specified in Step S306, for example, information spot 10A to which the identifier of car B is to be transmitted.

Next, information spot 10C transmits the identifier of car B to information spot 10 specified in Step S307 (S308). Here, information spot 10C transmits the identifier of car B to, for example, information spot 10A specified in Step S307.

Next, when information spot 10A receives the identifier of car B (S309), information spot 10A stores the received identifier of car B into storage 12. In this way, information spot 10A obtains the identifier of car B different from car A from, for example, information spot 10C different from information spot 10A itself.

Next, by determining whether the short-range wireless communication with car B is available, information spot 10A determines whether car B is approaching (S310). Here, by determining whether there is a match between the identifier of a car obtained when the short-range wireless communication is established and the identifier of car B obtained from information spot 10C, information spot 10A can determine whether the short-range wireless communication with car B has become available. In this way, information spot 10A can determine whether car B is approaching. When information spot 10A determines in Step S310 that the short-range wireless communication with car B has become available (YES in S310), information spot 10A transmits information Y of road X to car B (S311). Note that when information spot 10A determines in Step S310 that the short-range wireless communication with car B is not available (NO in S310), the processing returns to Step S310.

Next, car B receives information Y of road X transmitted from information spot 10A in Step S311 (S312).

In this way, car A and car B can transmit and receive information via information spot 10; thus, car A and car B can exchange information even without having to pass each other.

Note that with reference to FIG. 14, the first information is described as the information obtained on road X, but this is not limiting. The first information may be metadata generated from information Y obtained on road X.

### Variation 2

Taking the example illustrated in FIG. 7, even when, for example, information spot 10C requests another information spot 10 to transmit the first information thereto and thus obtains the first information, mobile body 20B may have already traveled past the location of information spot 10C upon the obtainment of the first information, and therefore it may not be possible to transmit the first information to mobile body 20B. The operation of information spot 10C in which this case has been taken into consideration will be described below as Variation 2.

### [Operation of Information Spot 10]

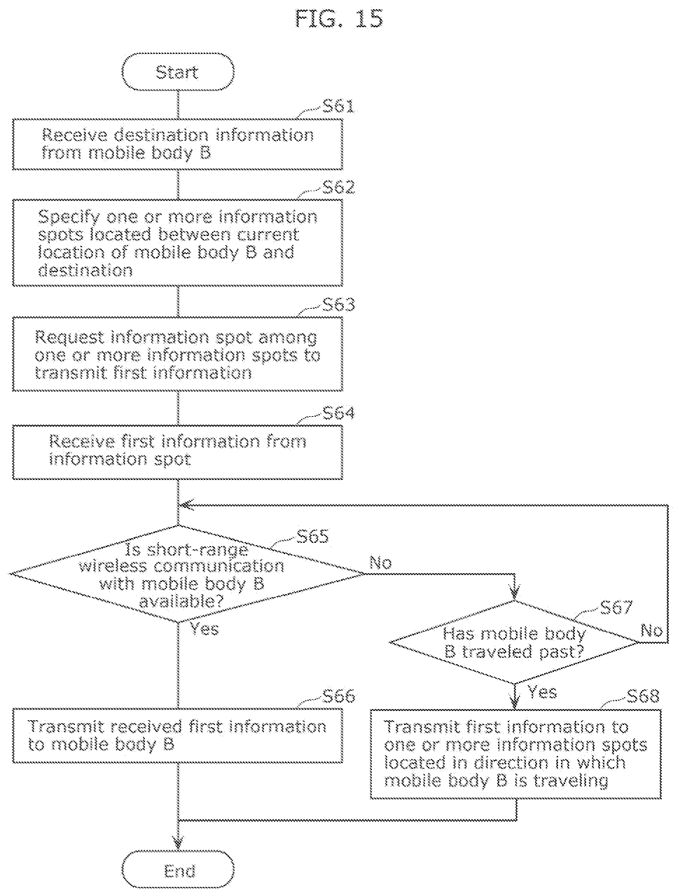

FIG. 15 is a flowchart illustrating one example of the operation of information spot 10C according to Variation 2 of Embodiment 2. Note that Steps S61 to S64 are operations that are substantially the same as the operations of Steps S31 to S34 described with reference to FIG. 10 and therefore, description of Steps S61 to S64 will be omitted.

When information spot 10C receives the first information from one information spot 10 in Step S64, information spot 10C determines whether the short-range wireless communication with mobile body B is available (S65).

When information spot 10C determines in Step S65 that the short-range wireless communication with mobile body B has become available (YES in S65), information spot 10C transmits, to mobile body B, the first information received in Step S64 (S66).

On the other hand, when the short-range wireless communication with mobile body B has not become available in Step S65 (NO in S65), information spot 10C further determines whether mobile body B has traveled past the location of information spot 10C (S67).

When information spot 10C determines in Step S67 that mobile body B has not traveled past the location of information spot 10C (NO in S67), the processing returns to Step S65.

On the other hand, when information spot 10C determines in Step S67 that mobile body B has traveled past the location of information spot 10C (YES in S67), information spot 10C transmits the first information to one or more information spots 10 located in a direction in which mobile body B is traveling. In the example illustrated in FIG. 7, information spot 10C may transmit the first information to, for example, information spot 10B located in the direction in which mobile body B is traveling.

### [Example Process]

Hereinafter, an example of processing performed by three information spots 10A, 10B, 10C and two mobile bodies 20A, 20B in the case where information spot 10C performs the operation will be described as a specific embodiment of the method for controlling information spot 10.

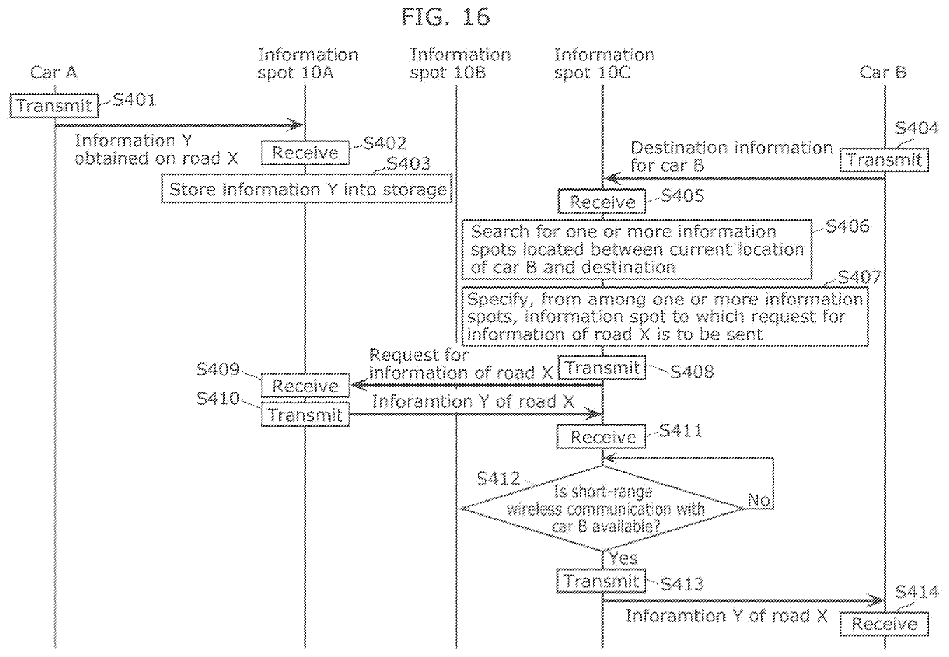

FIG. 16 is a sequence chart illustrating an example process performed by mobile bodies and a plurality of information spots according to Variation 2 of Embodiment 2. Similar to FIG. 14 and FIG. 11, FIG. 16 assumes that mobile body 20A is car A, mobile body 20B is car B, and there are information spots 10A, 10B, 10C placed on respective signal lights as illustrated in FIG. 7, for example. Furthermore, description will be given assuming that in the sequence illustrated in FIG. 16, car A travels on road X to the location of information spot 10A, and car B travels to the location of information spot 10C, then travels on a road on which information spot 10B is present, travels on road X on which information spot 10C is present, and reaches a destination that is the intermediate destination of car B.

Note that Steps S401 to S403 are processes that are substantially the same as Steps S301 to S303 described with reference to FIG. 14 and therefore, description of Steps S401 to S403 will be omitted. Furthermore, Steps S404 to S411 are processes that are substantially the same as Steps S206 to S213 described with reference to FIG. 11 except that instead of the metadata of information Y obtained on road X, information Y obtained on road X is exchanged, and therefore description of Steps S404 to S411 will be omitted.

When information spot 10C obtains information Y of road X from information spot 10A in Step S411, information spot 10C determines whether the short-range wireless communication with car B is available (S412).

When information spot 10C determines that the short-range wireless communication with car B has become available in Step S412 (YES in S412), information spot 10C transmits information Y of road X to car B (S413). On the other hand, when information spot 10C determines that the short-range wireless communication with car B is not available (NO in S412), the processing returns to Step S412.

Next, car B receives information Y transmitted from information spot 10C in Step S413 (S414).

Note that when information spot 10C determines in Step S412 that the short-range wireless communication with car B is not available (NO in S412), information spot 10C may further determine whether car B has traveled past the location of information spot 10C. When car B has not traveled past, it is sufficient that the processing return to Step S412, and when car B has traveled past, it is sufficient that information Y of road X and the identifier of car B be transmitted to information spots 10B, 10A. Thus, information spot 10B or 10C to which the short-range wireless communication with car B has become available provides information Y of road X to car B.

### [Advantageous Effects, Etc.]

As described above, with the control method, etc., according to Embodiment 2, etc., by using at least one of the plurality of information spots placed on at least one of a traffic light and roadside equipment, the first mobile body and the second mobile body can exchange information without passing each other. Thus, the mobile bodies can exchange information even without having to pass each other.

For example, among the plurality of information spots, the first information spot obtains the identifier of the second mobile body from another information spot, that is, the second information spot, and thus can determine an approach of the second mobile body on the basis of the obtained identifier. Thus, the first information spot can provide, to the second mobile body, the first information of the first path obtained from the first mobile body. In this way, the first information obtained by the first mobile body from the first path can be provided to the second mobile body via the plurality of information spots, meaning that the mobile bodies can exchange information even without having to pass each other.

Furthermore, for example, among the plurality of information spots, the first information spot obtains, from another information spot, that is, the second information spot, the first information of the first path obtained by the second mobile body, and thus can provide the obtained first information to the first mobile body. Thus, the first information obtained by the second mobile body from the first path can be provided to the first mobile body via the plurality of information spots, meaning that the mobile bodies can exchange information even without having to pass each other.

Note that the first information spot obtains, from another information spot, that is, the second information, the first information of the first path obtained by the second mobile body, but there are cases where the first information spot cannot provide the first information to the first mobile body due to, for example, the first mobile body having traveled past the location of the first information spot. Even in this case, the first information spot can provide the identifier of the first mobile body together with the first information to another information spot and thus cause the other information spot to provide the first information to the first mobile body. Thus, the first information obtained by the second mobile body from the first path can be provided to the first mobile body via the plurality of information spots, meaning that the mobile bodies can exchange information even without having to pass each other.

### Embodiment 3

Embodiments 1 and 2 have indicated that when each of the plurality of information spots 10 receives the destination information from mobile body 20, the information spot stores the destination information into storage 12 of the information spot itself, but this is not limiting.

Each of the plurality of information spots 10 may include a distributed ledger; when each of the plurality of information spots 10 receives the destination information from mobile body 20, the information spot may record the received destination information into the distributed ledger. Here, the distributed ledger is a distributed ledger of the blockchain, for example, but is not limited thereto as long as the distributed ledger includes a plurality of ledgers containing the same content that are built on the blockchain platform. A distributed ledger in another form (such as IOTA or hashgraph, for example) may be used as the distributed ledger.

Hereinafter, the case where the first mobile body and the second mobile body exchange information without passing each other using a plurality of information spots 10 in each of which the destination information for mobile body 20 is stored into a distributed ledger of the information spot itself will be described as Embodiment

### [Outline]

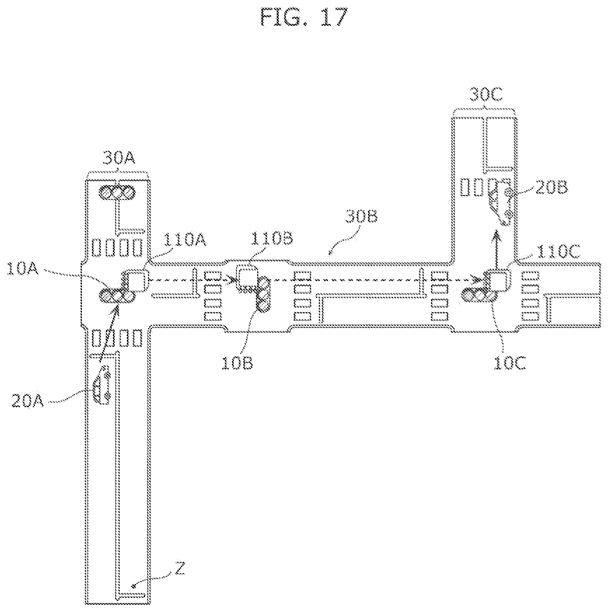

FIG. 17 is a diagram schematically illustrating a situation in which mobile bodies 20 use the plurality of information spots 10 according to Embodiment 3. Elements that are substantially the same as those in FIG. 1 and FIG. 7, etc., are assigned the same reference signs and detailed description thereof will be omitted.

FIG. 17 illustrates information spots 10A, 10B, 10C placed on respective signal lights. Furthermore, FIG. 17 schematically illustrates that distributed ledgers 110A, 110B, 110C are provided in information spots 10A, 10B, 10C. In the following description, there are also cases where distributed ledgers 110A, 110B, 110C are collectively referred to as distributed ledger 110.

In the example illustrated in FIG. 17, mobile body 20A travels on road 30A and transmits, as the first information to information spot 10A via the short-range wireless communication, the information obtained from road 30A on which mobile body 20A has traveled to reach the location of information spot 10A and indicating a situation on road 30A. The first information includes information indicating a situation on at least one road included in the first path such as information indicating a situation on road 30A, for example.

Meanwhile, mobile body 20B travels on road 30C and after traveling past the location of information spot 10C, transmits, to information spot 10C via the short-range wireless communication, destination information including destination Z for which mobile body 20B is to head by traveling on road 30B and road 30C. In the present exemplary embodiment, description will be given assuming that when approaching the location of information spot 10, mobile body 20B obtains, from information spot 10A via the short-range wireless information, the information indicating a situation related to at least road 30A, out of roads 30B and 30A on which mobile body 20B is to travel to reach destination Z, for example.

### [Configuration]

Information spot 10 according to the present exemplary embodiment includes a recorder (not illustrated in the drawings) and distributed ledger 110 in addition to the functional configuration illustrated in FIG. 8.

The recorder includes, into a block, transaction data included in the destination information and stores the block into distributed ledger 110, thereby recording the destination information into distributed ledger 110. In the present exemplary embodiment, together with other information spots 10, the recorder executes a consensus algorithm for reaching an agreement about the validity of the transaction data included in the destination information. When the recorder confirms the validity of the transaction data, the recorder includes, into a block, transaction data included in the destination information and stores the block into distributed ledger 110. Note that as one example of the distributed ledger technology, when hyperledger fabric is used, there is no need to execute the consensus algorithm.

Note that as the aforementioned consensus algorithm, practical byzantine fault tolerance (PBFT) may be used, or other known consensus algorithms may be used. Examples of the known consensus algorithms include proof of work (PoW) and proof of stake (PoS).

In distributed ledger 110, the destination information is stored. In the present exemplary embodiment, in distributed ledger 110, a block including one or more items of the transaction data included in the destination information for mobile body 20B is stored and thus, the destination information for mobile body 20B is stored.

### [Example Process]

Hereinafter, an example of processing performed by information spots 10 and mobile bodies 20 will be described as a specific embodiment of the method for controlling information spot 10 according to Embodiment 2.

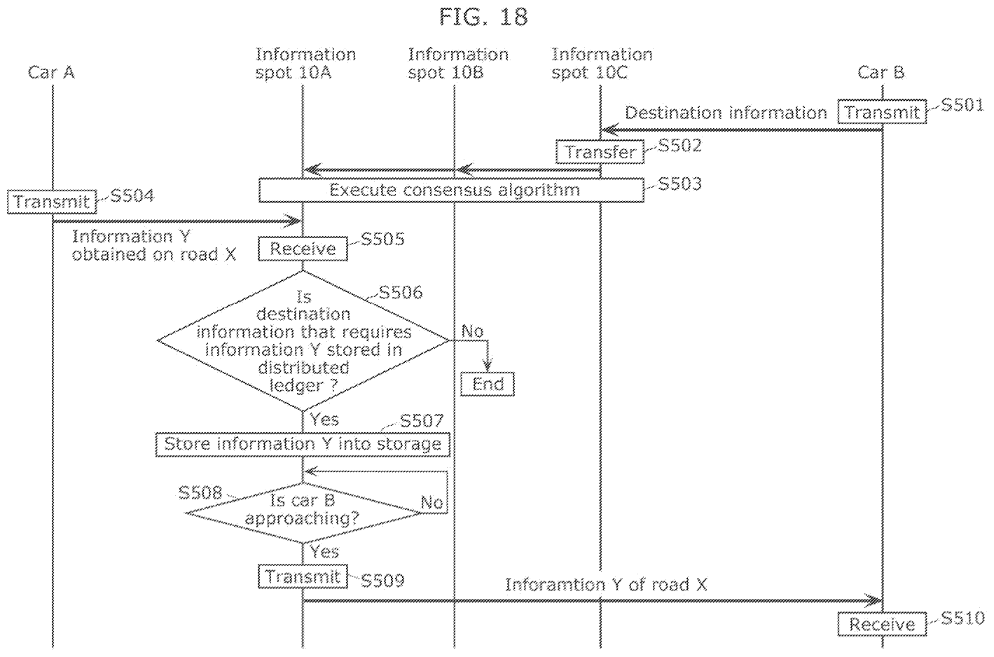

FIG. 18 is a sequence chart illustrating an example process performed by mobile bodies 20 and the plurality of information spots 10 according to Embodiment 3.

First, when the short-range wireless communication with information spot 10C becomes available to car B during travel on a road, car B transmits, to information spot 10C, destination information for car B which is related to the destination of car B, as indicated in FIG. 18 (S501). In the present exemplary embodiment, car B generates transaction data including the destination information for car B and transmits the generated transaction data to information spot 10C.

Next, when information spot 10C receives the destination of car B transmitted in S501, specifically, the transaction data including the destination information for car B, information spot 10C transfers said transaction data to other information spots 10, specifically, information spot 10A and information spot 10B (S502). Specifically, information spot 10 receives the transaction data and when the validity of the received transaction data is successfully verified, information spot 10 transfers the transaction data to other information spots 10A, 10B, and further records the transaction data into the storage. In this manner, information spot 10 records only the transaction data, the validity of which has been successfully verified, into the storage, and transfers only the transaction data, the validity of which has been successfully verified, to other information spots 10A, 10B, for example; therefore, the processing load on the processor can be reduced, and unnecessary memory consumption can be reduced, for example.

Next, information spots 10A, 10B, 10C execute the consensus algorithm, generate a block including the transaction data, and stores the block into distributed ledger 110 (S503).

Meanwhile, when car A reaches the location of information spot 10A after traveling on road X, car A transmits, to information spot 10A via the short-range wireless communication, information Y obtained on road X while traveling on road X (S504). Note that car A may generate metadata of information Y obtained on road X and transmit the generated metadata to information spot 10A as information Y obtained on road X. Road X and information Y obtained on road X are as described with reference to FIG. 4 and therefore, description thereof will be omitted.

Next, when information spot 10A receives information Y of road X transmitted in Step S504 (S505), information spot 10A checks whether destination information that requires received information Y of road X is stored in distributed ledger 110 (S506). More specifically, information spot 10A checks whether the path leading to the destination obtained from the destination information includes road X, thereby checking whether destination information that requires received information Y of road X is stored in distributed ledger 110.

When the destination information the requires information Y of road X is stored in distributed ledger 110 in Step S506 (YES in S506), information Y of road X received in Step S505 is stored into storage 12 (S507). Note that when the destination information the requires information Y of road X is not stored in distributed ledger 110 in Step S506 (NO in S506), the processing ends.

Next, information spot 10A determines whether car B is approaching (S508). Here, by determining whether the short-range wireless communication with car B is available, information spot 10A determines whether car B is approaching.

When information spot 10A determines in Step S508 that car B is approaching (YES in S508), information spot 10A transmits information Y of road X to car B (S509). Note that when information spot 10A determines in Step S508 that the short-range wireless communication with car B is not available (NO in S508), the processing returns to Step S508.

Next, car B receives information Y of road X transmitted from information spot 10A in Step S509 (S510).

In this way, using the plurality of information spots 10 in each of which the destination information for car B is stored into the distributed ledger of the information spot itself, car A and car B can exchange information even without having to pass each other. Note that the foregoing has described an example where after the transaction data including the destination information for car B is generated and stored into the distributed ledger, the metadata of information Y of road X is generated and transmitted to the information spot, but this is not limiting. Car B may transmit the destination information to the information spot after car A generates the transaction data including information Y of road X and stores the transaction data into the distributed ledger. More specifically, when information spot 10A receives the destination information for car B via the short-range wireless communication, information spot 10A may check whether the information related to road X included in the path leading to the destination obtained from the destination information is stored in distributed ledger 110, and when said information is stored in distributed ledger 110, information spot 10A may transmit, to car B, information Y of road X stored in the distributed ledger 110.

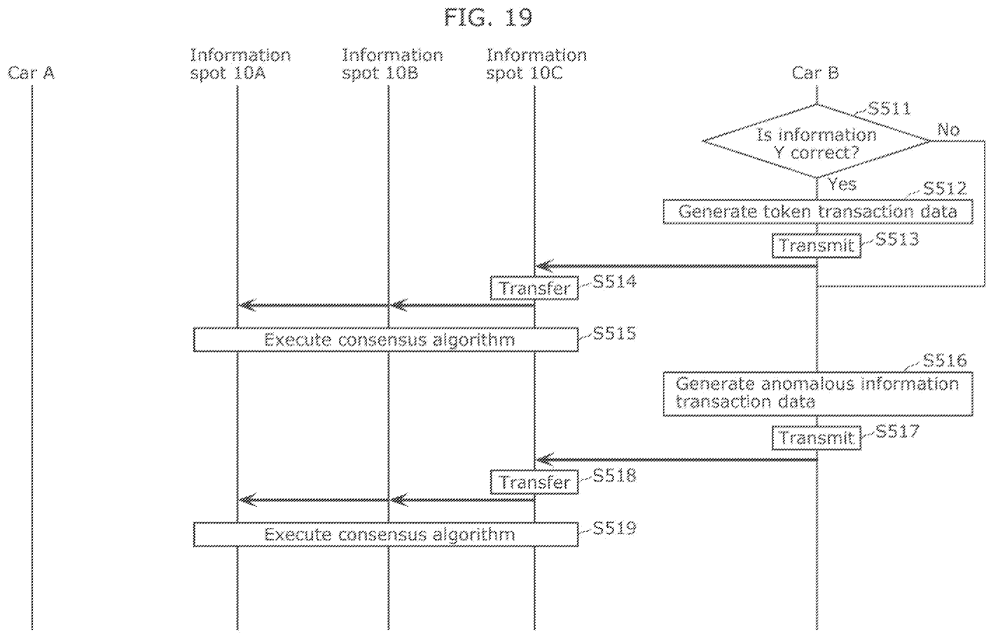

FIG. 19 is a sequence chart illustrating an example process according to Embodiment 3 in which an evaluation on whether information obtained by mobile body 20B is correct is stored into distributed ledger 110.

FIG. 19 indicates processing in which when information Y of road X obtained by car B in FIG. 18 is correct, an incentive is given to car A that has provided information Y, and when information Y is not correct, information to that effect is recorded.

First, car B determines whether information Y transmitted from information spot 10A is correct (S511).

When information Y is determined as being correct in Step S511 (YES in S511), car B generates token transaction data indicating that information Y is correct (S512) and transmits the token transaction data to information spot 10C via the short-range wireless communication (S513). Note that car B may transmit the token transaction data to any of the plurality of information spots 10 with which car B can perform the short-range wireless communication after traveling on road X.

Next, when information spot 10C receives the token transaction data of car B transmitted in S513, information spot 10C transfers the token transaction data to other information spots 10, specifically, information spots 10A, 10B (S514).

Next, information spots 10A, 10B, 10C execute the consensus algorithm (S515). When the validity of the token transaction data is confirmed by information spots 10A, 10B, 10C executing the consensus algorithm, information spots 10A, 10B, 10C generate a block including the token transaction data and stores the block into distributed ledger 110. In this way, the token transaction data indicating that the information Y is correct is recorded into distributed ledger 110; thus, it is possible to give a token to car A that has provided correct information Y of road X. As a result, car A, etc., that is traveling on a road is encouraged to obtain and provide correct information of the road, which makes it possible to exchange more accurate information.

On the other hand, when it is determined in Step S511 that information Y is not correct (NO in S511), car B generates anomalous information transaction data indicating that information Y is not correct (S516) and transmits the anomalous information transaction data to information spot 10C via the short-range wireless communication (S517).

Next, when information spot 10C receives the anomalous information transaction data transmitted in S516, information spot 10C transfers the anomalous information transaction data to other information spots 10, specifically, information spots 10A, 10B (S518).

Next, information spots 10A, 10B, 10C execute the consensus algorithm (S519). When the validity of the anomalous information transaction data is confirmed by information spots 10A, 10B, 10C executing the consensus algorithm, information spots 10A, 10B, 10C generate a block including the anomalous information transaction data and stores the block into distributed ledger 110. In this way, the anomalous information transaction data indicating that information Y is not correct is recorded into distributed ledger 110; thus, it is possible to prevent information Y from being provided to other cars.

The transaction data includes transaction body P1 and digital signature P2. Transaction body P1 is a data body included in the transaction data. Digital signature P2 is generated using a signing key of a creator of the transaction data for the hash value of transaction body P1; more specifically, digital signature P2 is generated by encrypting the hash value with a private key of the creator of the transaction data. Examples of usable means for providing the digital signature include ECDSA, CRYSTALS-DILITHIUM, FALCON, and SPHINCS+.

Since the transaction data includes digital signature P2, tampering with the transaction data is virtually impossible. This is because, if the transaction data is tampered with, the verification using digital signature P2 fails, revealing that the transaction data has been tempered with. This prevents transaction body P1 from being tampered with.

Note that the present disclosure has been described thus far based on the above exemplary embodiments, but it goes without saying that the present disclosure is not limited to the above exemplary embodiments. The present disclosure also includes cases such as those described below.

(1) Each of the devices according to the above exemplary embodiments is specifically a computer system configured of a microprocessor, a read only memory (ROM), a random access memory (RAM), a hard disk unit, a display unit, a keyboard, and a mouse, for example. A computer program is recorded on the RAM or the hard disk unit. The microprocessor achieves its function by way of the microprocessor operating according to the computer program. Here, the computer program is configured of a combination of command codes indicating instructions to the computer in order to achieve a predetermined function.

(2) Some or all of the structural elements included in each of the devices according to the above exemplary embodiments may be configured from a single system Large Scale Integration (LSI). A system LSI is a super-multifunction LSI manufactured with a plurality of components integrated on a single chip, and is specifically a computer system configured of a microprocessor, ROM, and RAM, for example. A computer program is recorded on the RAM. The system LSI achieves its function by way of the microprocessor operating according to the computer program.

Furthermore, each unit of the structural elements included in each of the devices described above may be individually configured into a single chip, or some or all of the units may be configured into a single chip.

Moreover, although a system LSI is mentioned here, the integrated circuit can also be called an IC, a LSI, a super LSI, and an ultra LSI, depending on the level of integration. Furthermore, the method of circuit integration is not limited to LSIs, and implementation through a dedicated circuit or a general-purpose processor is also possible. A field programmable gate array (FPGA) which allows programming after LSI manufacturing or a reconfigurable processor which allows reconfiguration of the connections and settings of the circuit cells inside the LSI may also be used.

In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

(3) Some or all of the structural elements included in each of the devices described above may be configured from a standalone module or an IC card that can be inserted into and removed from the device. The IC card or the module is a computer system made up of a microprocessor, ROM, RAM, and so on. The IC card or the module may include the aforementioned super multifunctional LSI. The IC card or the module achieves its functions by way of the microprocessor operating according to the computer program. The IC card and the module may be tamperproof.

(4) The present disclosure may be the above-described methods. Furthermore, the present disclosure may be a computer program for implementing these methods using a computer or may be a digital signal of the computer program.

Furthermore, the present disclosure may be a computer program or a digital signal recorded on a computer-readable recording medium, such as a flexible disk, a hard disk, CD-ROM, a magneto-optical disc (MO), a digital versatile disc (DVD), DVD-ROM, DVD-RAM, a Blu-ray (registered trademark) disc (BD), or semiconductor memory, for example. The present disclosure may also be the digital signal recorded on these recoding media.

Furthermore, in the present disclosure, the computer program or the digital signal may be transmitted via an electrical communication line, a wireless or wired communication line, a network represented by the Internet, data broadcasting, or the like.

Furthermore, the present disclosure may be a computer system including a microprocessor and memory. The memory may have the computer program recorded therein, and the microprocessor may operate according to the computer program.

Moreover, by transferring the recording medium having the program or the digital signal recorded thereon or by transferring the program or the digital signal via the network or the like, the present disclosure may be implemented by a different independent computer system.

(5) The above-described exemplary embodiments and the above-described variations may be combined with each other.

### INDUSTRIAL APPLICABILITY

The present disclosure is applicable, for example, in devices placed on roadsides such as traffic lights and roadside equipment, information spots placed near said devices, methods for controlling the information spots, or the like.

1. A method for controlling an information spot placed on at least one of a traffic light or roadside equipment, the method comprising:
obtaining first information from a first mobile body via short-range wireless communication, the first information being obtained from a first path along which the first mobile body has traveled to reach a location of the information spot and indicating a situation on the first path;
obtaining information related to a destination of a second mobile body from the second mobile body via the short-range wireless communication, the second mobile body being different from the first mobile body; and
transmitting the first information to the second mobile body when it is determined that the second mobile body is to travel along the first path to reach the destination.

2. The method according to claim 1, wherein
in the transmitting of the first information to the second mobile body, the first information is transmitted to the second mobile body when a second path along which it is determined that the second mobile body is to travel to reach the destination includes a section that partially overlaps the first path.

3. The method according to claim 1, wherein
in the obtaining of the information related to the destination of the second mobile body via the short-range wireless communication,
a second path along which the second mobile body is to travel to reach the destination is obtained from the second mobile body, and
in the transmitting of the first information to the second mobile body,
the first information is transmitted to the second mobile body when the second path includes a section that partially overlaps the first path.

4. The method according to claim 1, wherein
the first information is information obtained from a sensor included in the first mobile body.

5. The method according to claim 4, wherein
the sensor is a dashboard camera, and
the first information is information obtained from the dashboard camera.

6. A method for controlling a first information spot included in a plurality of information spots each placed on at least one of a traffic light or roadside equipment, the method comprising:
obtaining first information from a first mobile body via short-range wireless communication, the first information being obtained from a first path along which the first mobile body has traveled to reach a location of the first information spot and indicating a situation on the first path;
obtaining, from a second information spot different from the first information spot, an identifier of a second mobile body different from the first mobile body; and
transmitting the first information to the second mobile body via the short-range wireless communication when it is determined based on the identifier that the second mobile body has approached the location of the first information spot.

7. A method for controlling a first information spot included in a plurality of information spots each placed on at least one of a traffic light or roadside equipment, the method comprising:
obtaining information related to a destination of a first mobile body from the first mobile body via short-range wireless communication;
obtaining first information from a second information spot different from the first information spot and located between a current location of the first mobile body and the destination, the first information being obtained from a first path along which the second mobile body has traveled to reach a location of the second information spot from the destination and indicating a situation on the first path; and
transmitting the first information to the first mobile body when the short-range wireless communication with the first mobile body is available.

8. The method according to claim 7, further comprising:
transmitting an identifier of the first mobile body and the first information to one or more information spots located in a direction in which the first mobile body is traveling, when the short-range wireless communication with the first mobile body is not available.

9. A non-transitory computer-readable recording medium having stored therein a program for causing a computer to execute a method for controlling an information spot placed on at least one of a traffic light or roadside equipment, the method including:
obtaining first information from a first mobile body via short-range wireless communication, the first information being obtained from a first path along which the first mobile body has traveled to reach a location of the information spot and indicating a situation on the first path;
obtaining information related to a destination of a second mobile body from the second mobile body via the short-range wireless communication, the second mobile body being different from the first mobile body; and
transmitting the first information to the second mobile body when it is determined that the second mobile body is to travel along the first path to reach the destination.

10. A non-transitory computer-readable recording medium having stored therein a program for causing a computer to execute a method for controlling a first information spot included in a plurality of information spots each placed on at least one of a traffic light or roadside equipment, the method including:
obtaining first information from a first mobile body via short-range wireless communication, the first information being obtained from a first path along which the first mobile body has traveled to reach a location of the first information spot and indicating a situation on the first path;
obtaining, from a second information spot different from the first information spot, an identifier of a second mobile body different from the first mobile body; and
transmitting the first information to the second mobile body via the short-range wireless communication when it is determined based on the identifier that the second mobile body has approached the location of the first information spot.

11. A non-transitory computer-readable recording medium having stored therein a program for causing a computer to execute a method for controlling a first information spot included in a plurality of information spots each placed on at least one of a traffic light or roadside equipment, the method including:
obtaining information related to a destination of a first mobile body from the first mobile body via short-range wireless communication;
obtaining first information from a second information spot different from the first information spot and located between a current location of the first mobile body and the destination, the first information being obtained from a first path along which the second mobile body has traveled to reach a location of the second information spot from the destination and indicating a situation on the first path; and
transmitting the first information to the first mobile body when the short-range wireless communication with the first mobile body is available.

12. An information spot placed on at least one of a traffic light or roadside equipment, the information spot comprising:
a processor; and
memory, wherein
the processor obtains first information from a first mobile body via short-range wireless communication, the first information being obtained from a first path along which the first mobile body has traveled to reach a location of the information spot and indicating a situation on the first path,
the processor obtains information related to a destination of a second mobile body from the second mobile body via the short-range wireless communication, the second mobile body being different from the first mobile body, and
the processor transmits the first information to the second mobile body when it is determined that the second mobile body is to travel along the first path to reach the destination.

13. A first information spot included in a plurality of information spots each placed on at least one of a traffic light or roadside equipment, the first information spot comprising:
a processor; and
memory, wherein
the processor obtains first information from a first mobile body via short-range wireless communication, the first information being obtained from a first path along which the first mobile body has traveled to reach a location of the first information spot and indicating a situation on the first path,
the processor obtains, from a second information spot different from the first information spot, an identifier of a second mobile body different from the first mobile body, and
the processor transmits the first information to the second mobile body via the short-range wireless communication when it is determined based on the identifier that the second mobile body has approached the location of the first information spot.

14. A first information spot included in a plurality of information spots each placed on at least one of a traffic light or roadside equipment, the first information spot comprising:
a processor; and
memory, wherein
the processor obtains information related to a destination of a first mobile body from the first mobile body via short-range wireless communication,
the processor obtains first information from a second information spot different from the first information spot and located between a current location of the first mobile body and the destination, the first information being obtained from a first path along which the second mobile body has traveled to reach a location of the second information spot from the destination and indicating a situation on the first path, and
the processor transmits the first information to the first mobile body when the short-range wireless communication with the first mobile body is available.
